(19) United States
(12) Patent Application Publication
(10) Pub. No.: US 2008/0225347 A1
(43) Pub. Date: Sep. 18, 2008

(54) Scanner Lighting

(76) Inventors: Peter G. Hwang, Vancouver, WA (US); Mark A. Smith, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/685,309

(22) Filed: Mar. 13, 2007

(51) Int. Cl. H04N 1/04

(52) U.S. Cl. 358/474

(57) ABSTRACT

In one embodiment, a scanning device that includes: a lamp; a light sensitive detector near the lamp, the detector configured to detect images on a scan target illuminated by the lamp; and a window for admitting light from the lamp to illuminate a specific part of the device that is not necessarily illuminated during a scanning operation.

### BACKGROUND

The non-articulating scan bed on some, typically less expensive, multi-function inkjet printing devices prevents access to the ink cartridges located below the scan bed except through an opening at the front of the device. For such devices in which the ink cartridges are positioned away from the front of the device, ambient lighting may not provide good visibility in the area of the ink cartridges.

### DRAWINGS

FIG. 1 is a perspective view illustrating a multi-function inkjet printing device according to one embodiment of the invention.

FIG. 2 is a perspective view illustrating the multi-function inkjet printing device of FIG. 1 with the front access door open.

FIG. 3 is a top plan view illustrating the device of FIG. 1 with the scan cover and front access door closed.

FIG. 4 is a top plan view illustrating the device of FIG. 1 with the scan cover and front access door open.

FIG. 5 is a close-up elevation view illustrating the ink cartridge bay in the device of FIG. 1 with a concave reflecting surface on the scan cover.

FIG. 6 is a close-up elevation view illustrating the ink cartridge bay in a device such as the device of FIG. 1 with a flat reflecting surface on the scan cover.

FIG. 7 is a close-up perspective view illustrating the scanner lighting window in the device of FIG. 1.

FIG. 8 is a block diagram illustrating a multi-function inkjet printing device such as the device shown in FIG. 1.

### DETAILED DESCRIPTION

The new scanner lighting was developed in an effort to improve visibility in the area of the ink cartridges in flatbed multi-function inkjet printing/scanning devices that do not have an articulating scan bed. The new scanner lighting will be described, therefore, with reference to a flatbed multi-function inkjet printing and scanning device. The new scanner lighting, however, is not limited to use in a multi-function inkjet printing and scanning device, or even in a flatbed scanner, but may be used in a sheet-feed scanning device or any scanning device in which it may be desirable to illuminate with the scanner lamp parts of the device not necessarily illuminated during a scanning operation.

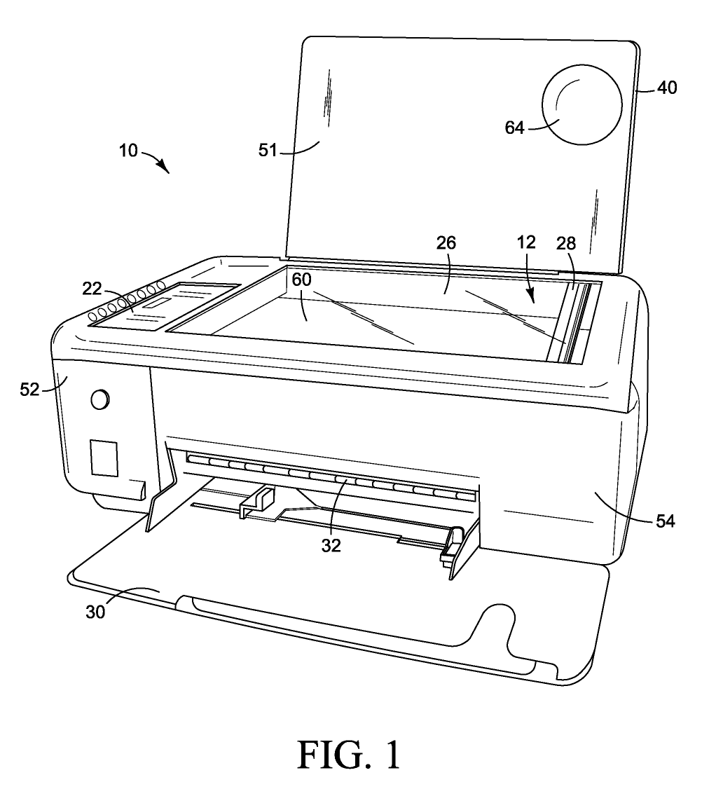

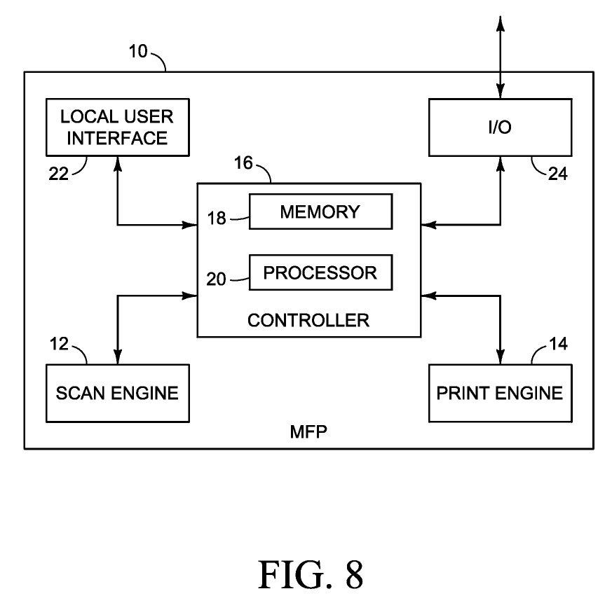

FIGS. 1-2 and 8 illustrate a multi-function inkjet printing device 10 that includes a scan engine 12 and a print engine 14 operating under the control of a electronic controller 16. (Controller 16 is shown only in FIG. 8.) A multi-function printing device, such as inkjet printing device 10, is commonly referred to as a multi-function peripheral (MFP) or an all-in-one printer. Controller 16 includes a memory 18 and a processor 20. Memory 18 may include a so-called “hard drive”, read only memory (ROM), and random access memory (RAM) for storing data and programming associated with all aspects of the multiple functions of device 10. Device 10 also includes a local user interface 22 and an input/output device 24 that allows device 10 to communicate with host computers or other external devices. While only a single controller 16 is shown, controller 16 may have constituent parts physically and/or logically associated with each of the scan engine 12 and the print engine 14.

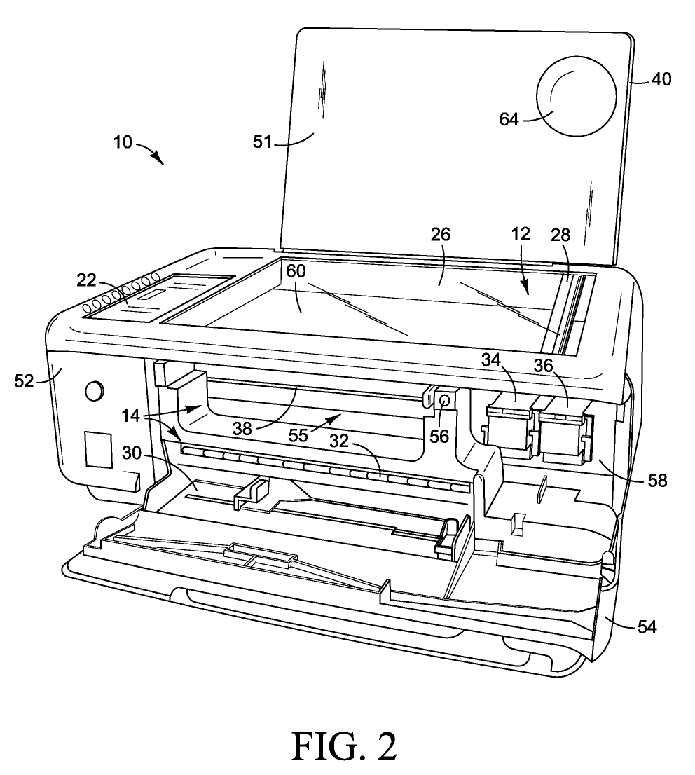

Scan engine 12 represents generally the structural and operational components for performing the scan function of device 10. In a flat bed scanning device like device 10, scan engine 12 includes, for example, a transparent plate 26, a scan head 28 (including the lamp and light detector) and a motorized carriage (not shown) that carries scan head 28 back and forth under plate 26 at the direction of controller 16. Transparent plate 26 is commonly referred to as the “scan glass.” Print engine 14 represents generally the structural and operational components for performing the print function of device 10. In an inkjet printing device like device 10, print engine 14 includes, for example, a media feed tray 30, feed rollers (not shown), media discharge rollers 32, ink cartridges 34, 36 mounted to a motorized carriage (not shown) that carries cartridges 34, 36 along a rail 38 (visible in FIG. 2) back and forth across the media print zone at the direction of controller 16.

The components of device 10 described above represent well known components of a conventional MFP that may be readily adapted to the new scanner lighting, which is described in detail below. (Device 10 shown in FIGS. 1 and 2 is modeled after the HP Photosmart C3180 all-in-one printer.)

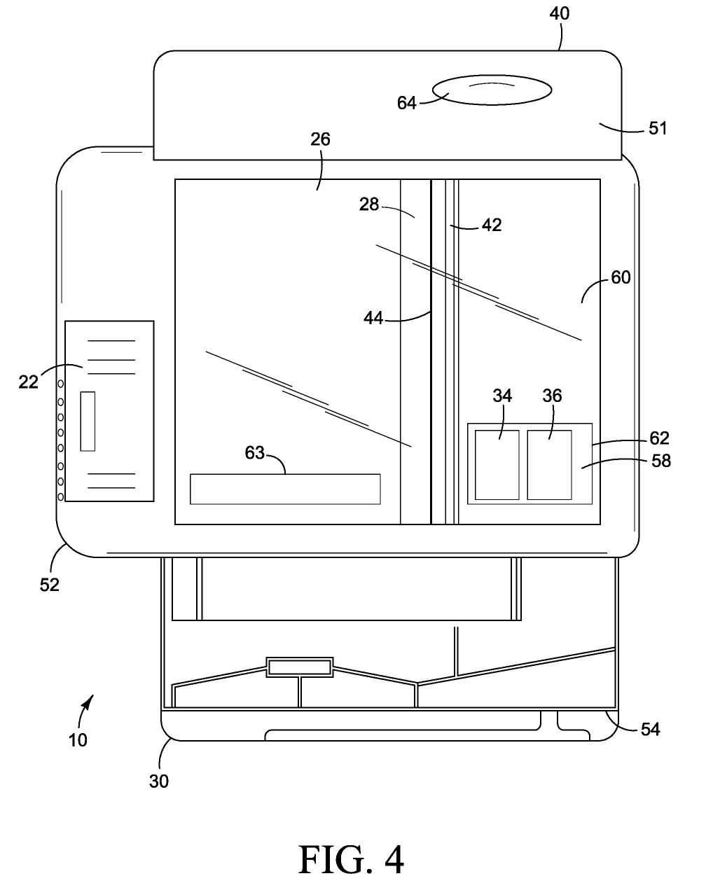

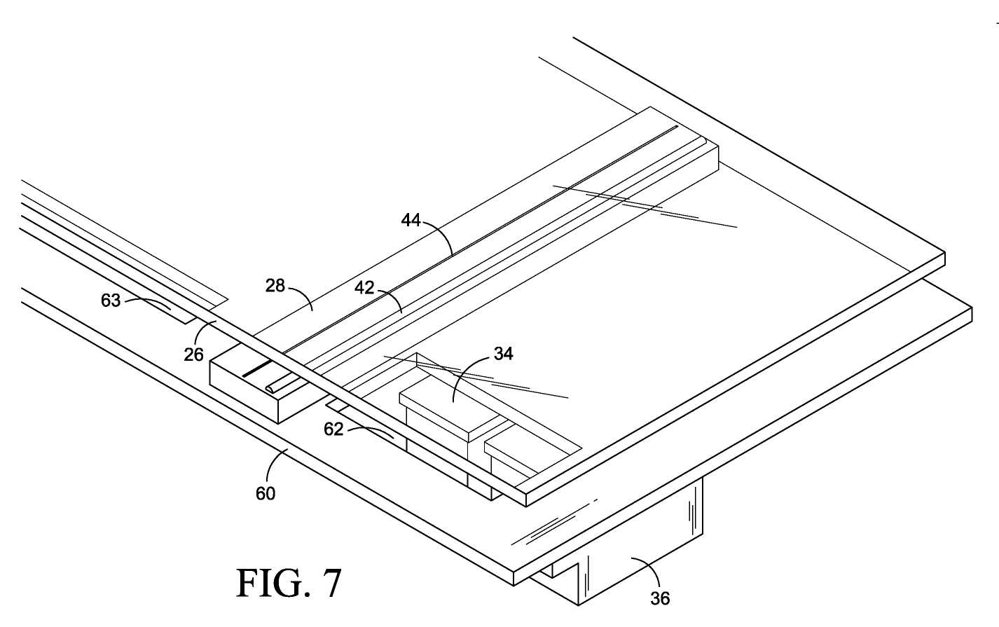

Referring now to FIGS. 1-5 and 7, MFP device 10 includes a cover 40, hinged at the back of device 10, that opens and closes to expose or cover plate 26 as may be necessary or desirable for a particular scanning operation. In a typical scanning operation, a document or other scan target on plate 26 is illuminated by a lamp 42 on scan head 28. As scan head 28 moves across the target, light reflected from the target passes through a narrow slot 44 in scan head 28 to a light sensitive detector 46 (seen in FIG. 4). The light may be focused on detector 46 and otherwise manipulated by mirror 48 and lense 50 (FIG. 4) in scan head 28. A charge-coupled device (CCD) array is one example of a light sensitive detector 46 used in many scanners for detecting the optical image of the target and converting it into a digital electronic image. A white or other light reflecting scan target backer 51 attached to or integrated with the inside of cover 40 provides a uniform background to the scan target.

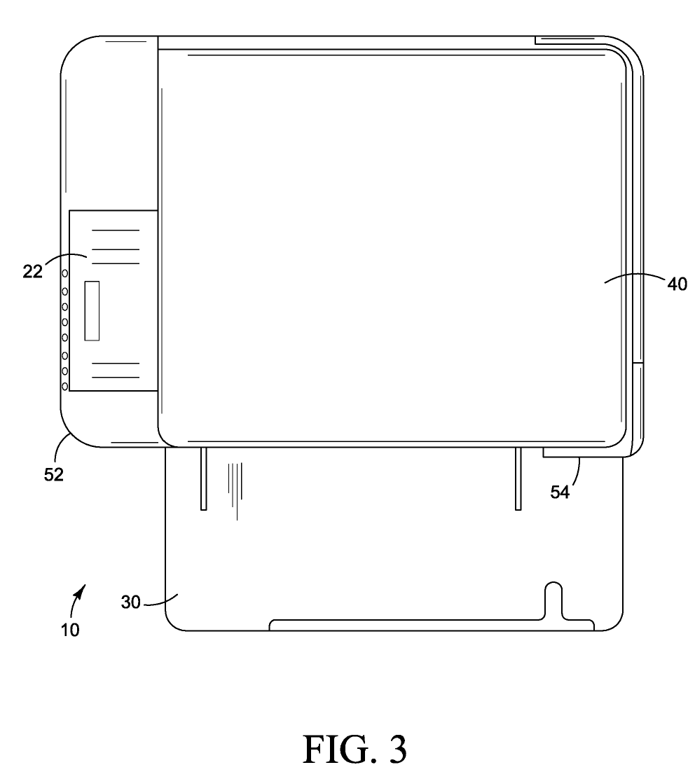

The operational components of device 10 are enclosed in and generally supported by a housing 52. As best seen by comparing FIGS. 1 and 2, an access door 54 at the front of housing 52 drops down to expose part of print engine 14, including ink cartridges 34 and 36, and a printing zone 55 where cartridges 34 and 36 are carried back and forth over a sheet of paper or other print media on carriage rail 38. Like many conventional inkjet printers and MFPs, device 10 includes a sensor, switch or other detector 56 that signals controller 16 when access door 54 is open. In response, ink cartridges 34 and 36 are automatically moved to an access bay 58 at a far right position shown in the figures when access door 54 is opened to make ink cartridges 34 and 36 accessible to the user for removal and installation. Access door 54 is open in FIGS. 2 and 4 and closed in FIGS. 1 and 3.

Referring now to FIGS. 4, 5 and 7, a scan bed 60 isolates scan head 28 from print engine 14 and other components in the lower part of device 10. An opaque scan bed 60 also helps prevent the light from lamp 42 from dispersing to other parts of device 10. Scan bed 60 is often constructed as an opaque molded plastic sheet underlying the operative coverage area of scan head 28. A window 62 is formed in scan bed 60 over cartridge access bay 58 (the area occupied by ink cartridges 34 and 36 when access door 54 is open). A window 63 may also be formed in scan bed 60 over print zone 55 (an area paper jams sometimes occur). The size, shape and position of the scan bed may vary depending on the type of scanner and the environment in which the scanner is used. The scan bed in a sheet-fed scanner used in many less expensive MFPs, for example, may be a long and comparative narrow part immediately adjacent to the stationary scan head. Also, the scan bed need not be a single integrated part or a part that performs solely as the scan bed. Therefore, the term “opaque scan bed” as used in the claims means any structural feature that would otherwise (but for the window in the scan bed) prevent the light from a scan lamp from illuminating a specific area of the device.

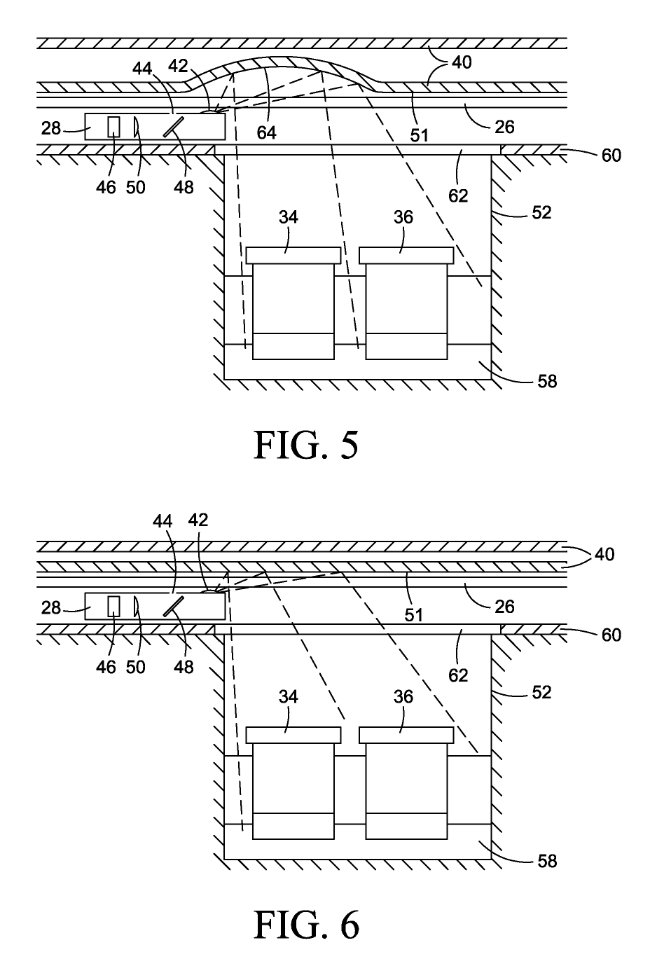

As noted above, when access door 54 is opened, detector 56 signals controller 16 that door 54 is opened. In response, controller 16 directs print engine 14 to position ink cartridges 34 and 36 in the access bay (if they are not already there) and scan engine 12 to position scan head 28 so that lamp 42 is near window 62, as shown in FIG. 5. Controller 16 also directs scan engine 12 to energize scan lamp 42. In the embodiment shown in FIG. 5, light from lamp 42 reflects off a concave or other suitably shaped area 64 in reflective backer 51 into access bay 58. Scan head 28 may remain energized and in position near window 62 until access door 54 is closed or for a predetermined period of time, or both (e.g., whichever comes first). Alternatively, in response to the opening of access door 54, controller 16 may direct scan engine 12 to position scan head 28 near window 63 and energize scan lamp 42 to illuminate print zone 55. A shaped area of backer 51 could also be used to help reflect light through window 63.

Controller 16 may be programmed or otherwise configured to automatically select the appropriate station for scan head 28. For example, where a single access door 54 is used, controller 16 may automatically station scan head 28 near window 63 when door 54 is opened if a paper jam has been detected. For a printer with separate access doors to the cartridge bay and the print zone, the controller may be configured to position the scan lamp near the appropriate window in response to a signal indicating which of the two access doors was opened. Also, or alternatively, the user might be allowed to select the scan head station through the printer control panel or through a user interface on a host device. For a printer with a transparent scan bed, or no scan bed, the scan head would be stationed at the desired location, near the cartridge bay for example, and the lamp energized as described above to illuminate the desired area of the printer.

The present invention has been shown and described with reference to the foregoing exemplary embodiments. It is to be understood, however, that other forms, details and embodiments may be made without departing from the spirit and scope of the invention which is defined in the following claims.

What is claimed is:

1. A scanning device, comprising:
a lamp;
a light sensitive detector near the lamp, the detector configured to detect images on a scan target illuminated by the lamp; and
a window for admitting light from the lamp to illuminate a specific part of the device that is not necessarily illuminated during a scanning operation.

2. The device of claim 1, further comprising:
a door for accessing the specific part of the device; and
a controller operatively connected to the door and the lamp, the controller configured to energize the lamp when the door is open.

3. The device of claim 2, wherein the controller is operatively connected to the door through a detector configured to signal the controller when the door is open.

4. The device of claim 1, further comprising:
a reflector opposite the lamp; and
an opaque scan bed near the lamp, the window formed in the scan bed for admitting light from the lamp reflected off the reflector to illuminate a specific part of the device behind the scan bed.

5. The device of claim 4, further comprising:
a movable scan head that includes the lamp and the detector; and
a transparent plate for receiving a scan target between the scan head and the reflector.

6. The device of claim 5, further comprising:
a door for accessing the specific part of the device; and
a controller operatively connected to the door and the scan head, the controller configured to position the scan head at a location where the lamp is near the window and energize the lamp when the door is open.

7. The device of claim 6, wherein the controller is configured to station the scan head at a location where the lamp is near the window and energize the lamp while the door is open.

8. A scanning device, comprising:
a transparent plate;
a reflective cover for covering the plate;
an opaque scan bed on one side of the plate opposite the cover;
a movable scan head between the scan bed and the plate, the scan head including a lamp for illuminating a scan target on the plate; and
a window in the scan bed, the window sized, shaped and positioned to allow light from the lamp reflected off the reflector to illuminate an area of the device behind the scan bed.

9. The device of claim 8, wherein the reflector includes a shaped area for reflecting light from the lamp through the window.

10. The device of claim 8, further comprising:
a door for accessing the area of the device behind the scan bed; and
an electronic controller operatively connected to the door and the scan head, the controller configured to position the scan head at a location where the lamp is near the window and energize the lamp when the door is open.

11. The device of claim 10, wherein the controller is operatively connected to the door through a detector configured to signal the controller when the door is opened.

12. A scanning device, comprising:
a scan engine including a lamp and a light sensitive detector configured to detect images on a scan target illuminated by the lamp;
a print engine; and
a electronic controller operatively connected to the scan engine and the print engine for controlling operation of the scan engine and the print engine, the controller configured to energize the lamp and station the energized lamp at a location where the lamp illuminates a desired part of the device not necessarily illuminated during a scanning operation.

13. The device of claim 12, wherein the print engine comprises an inkjet print engine including ink cartridges and the desired part of the device includes the print cartridges.

14. The device of claim 13, further comprising a window for admitting light from the lamp to illuminate the ink cartridges.

15. The device of claim 14, further comprising:
a transparent plate for receiving a scan target;
a reflective cover for covering the plate; and
a movable scan head that includes the lamp and the detector, the scan head positioned adjacent to the plate opposite the reflective cover.

16. The device of claim 15, further comprising a housing the scan engine, the print engine and the controller, the housing having a bay therein, and wherein the window for admitting light from the lamp to illuminate ink cartridges comprises a window near the bay for admitting light from the lamp to illuminate the ink cartridges parked in the bay.

17. The device of claim 16, further comprising a door for accessing ink cartridges parked in the bay, the controller operatively connected to the door, and wherein the controller is configured to move the scan head to a location where the lamp is near the window and energize the lamp when the door is open.
